(19) United States
(12) Patent Application Publication
(10) Pub. No.: US 2002/0079471 A1
(43) Pub. Date: Jun. 27, 2002

(54) INSTANTANEOUS, MULTISTAGE WATER-SAVING VALVE

(76) Inventor: Chung-Shan Shen, Taipei (TW)

Correspondence Address: Chung-Shan Shen, PO Box 82-144, Taipei, TW

(21) Appl. No.: 09/747,987

(22) Filed: Dec. 27, 2000

(51) Int. Cl. F16K 47/00

(52) U.S. Cl. 251/118

(57) ABSTRACT

The present invention relates to an instantaneous multistage and water-saving valve wherein a swinging rod is used to trigger the pushing element and the value, and the number of the sloping teeth on the engaging hook block can provide multiple stage of water flow rate so as to provide a rapid and convenient operation in supplying water. When the swinging rod is triggered so as to turn off water supply, the upper half of the pushing rod is urged and this will urge the pushing element to become slanting, and the end terminal edge will urge the blocking section of the cavity chamber. Thus, the valve is moved forward to achieve the turning on and turning off action in a multiple stage of operation.

### BACKGROUND OF THE INVENTION

1. Technical Field of the Invention

The present invention relates to a water-saving valve which allows the turning on and turning off in a multiple stage.

2. Description of the Prior Art

In order to improve the convenience and hygienic of faucet operation, electronic sensor faucet is developed. However, due to its high production cost and its complicated structure, it is not commonly found and installed to the faucets. Besides, the moisture and the humid environment around the faucet will damage the complicated components of the structure. In another type of conventional faucet, this conventional faucet controlled by swinging can only provide ON and OFF operation, i.e., either entire open or entire close of faucet and it cannot provide the exact required water flowrate. Thus, it is not convenient in operation and it is a waste of water if the right amount of water cannot be obtained.

### SUMMARY OF THE INVENTION

Accordingly, it is an object of the present invention to provide an instantaneous, multistage water-saving valve, wherein a swinging rod is used to trigger the pushing element and the value, and the number of the sloping teeth on the engaging hook block can provide multiple stage of water flowrate so as to provide a rapid and convenient operation in supplying water.

Yet a further object of the present invention is to provide an instantaneous, multistage water-saving valve, wherein the end terminal edge of the pushing rod urges the blocking section of the cavity chamber and the valve is pushed upward so that the turning on and turning off of water supply can be controlled via the method of multiple operations.

Other object and advantages of the present invention will become more apparent from the following description taken in conjunction with the accompanying drawing.

### BRIEF DESCRIPTION OF THE DRAWINGS

FIG. 1 is a schematic view showing the implementation of the multistage, water-saving valve of the present invention.

FIG. 2 is an exploded perspective view of the instantaneous, multistage, water-saving valve of the present invention.

FIG. 3 is a sectional view of the present invention.

FIG. 4 is a schematic view, illustrating low flow rate operation of the present invention.

FIG. 5 is a schematic view, illustrating high flow rate operation of the present invention.

FIG. 6 is a schematic view, illustrating the state of high flow rate in accordance with the present invention.

FIG. 7 is a schematic view, illustrating the turning off operation in accordance with the present invention.

FIG. 8 is a schematic view, illustrating the turning off operation in accordance with the present invention.

FIG. 9 is a sectional view at one angle in accordance with the present invention.

FIG. 10 is a partial sectional view in accordance with the present invention.

FIGS. 11 and 12 are schematic view of another preferred embodiment in accordance with the present invention.

### DETAILED DESCRIPTION OF THE PREFERRED EMBODIMENT

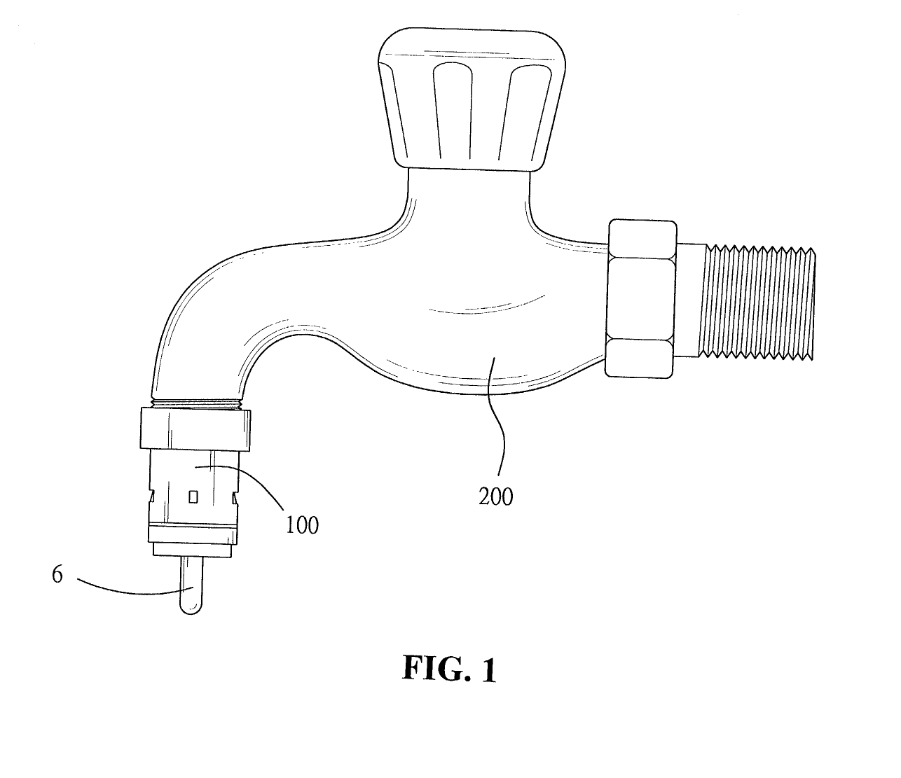

Referring to FIG. 1 there is shown an instantaneous, multistage water-saving valve mounted at the water outlet of a faucet 200.

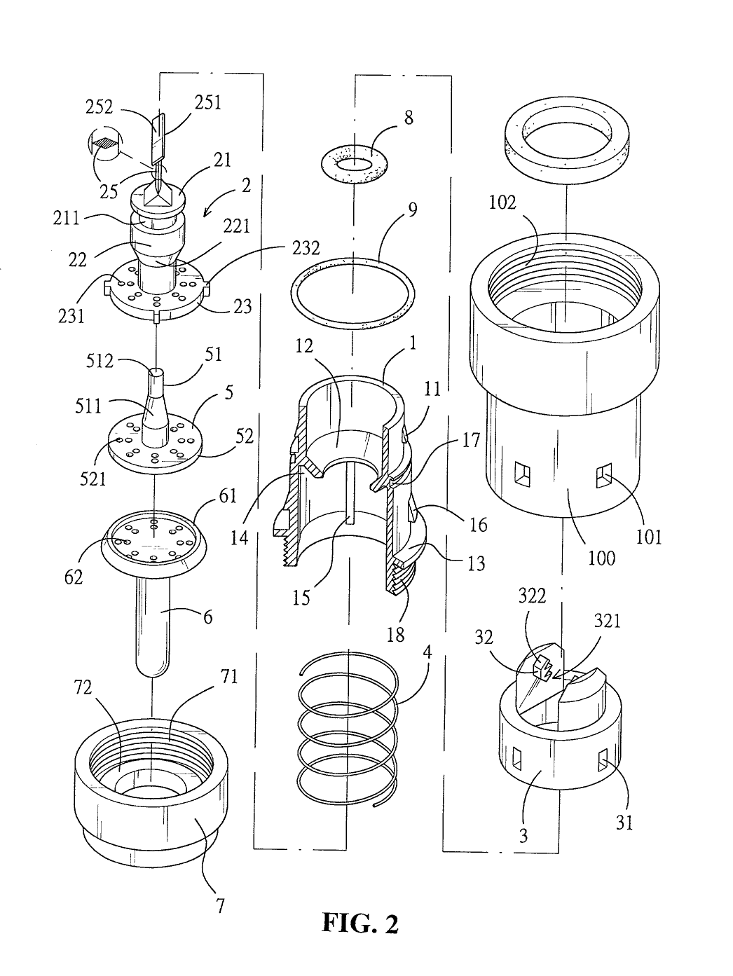

Referring to FIG. 2, the instantaneous, multistage water-saving valve comprises a valve seat 1, a valve 2, an engaging seat 3, and a pushing element 5, wherein the valve seat 1 having an external edge at the upper end opening is mounted with a plurality of engaging hooks 11. The upper end opening is provided with a sloping edge 12. The lower end opening is mounted externally with blocking edge 13, and the top of the blocking edge 13 is a plurality of engaging hooks 16 and the lower section is mounted with external threads, and the interior of the valve seat 1 is provided with a recess 17. The lower section of the blocking edge 13 is provided with external threads 18.

The valve 2 has one end being a valve head 21, and the top ring of the valve head 21 is a recess 211. The external edge of the tube body 22 is a sloping conic section 221 and the lower end thereof is a support plate 23. The support plate 23 and the center of the tube body 22 is provided with a cavity chamber 24 having a sloping conic section 241 at the interior thereof. The cavity chamber 24 is step-like structure. The lower section of the sloping conic section 241 is a bending region 242, and the support plate 23 is provided with a plurality of holes 231. The side edge of the support plate 23 has a plurality of positioning blocks 232, and the valve head 21 is provided with an engaging rod 25 with elasticity. The top end of the engaging rod 25 is connected to an engaging hook disc 251.

The engaging seat 3 has a hollow tube body with the top ring of the tube body being provided with a plurality of hooking holes 31, and the interior of the upper end is a pair of sloping teeth-shaped engaging blocks 32.

The pushing element 5 has a conic section 511 at the middle section of the push rod 51 of the upper section thereof such that the upper half of the push rod 51 is a smaller cylindrical body. The bottom of the push rod 51 is a pushing plate 52 having a plurality of holes 521.

In accordance with the above-mentioned structure of the present invention, a spring 4 is mounted into the valve 2, and the valve head 21 of the valve 2 passes through the valve seat 1 from the bottom thereof. The top end of the spring 4 is mounted within the circular slot 14, and the valve head 21 is protruded out from the valve seat 1 so that the sealing ring 8 is mounted onto the recess 211 of the valve head 21. At this instance, as the valve head 21 is mounted with the sealing ring 8, and the sealing ring 8 urges the sloping edge 12 of the valve seat 1, the valve head 21 will not be dislocated, but will seal water from leakage. When the valve 2 passes through the valve seat 1, the positioning protruded block 232 at the side edge of the support plate 23 of the valve 2 is aligned with the positioning sliding slot 15 of the valve seat 1, and the size of the positioning protruded block 232 and that of the individual sliding slot 15 are different, the alignment has to be accurate so as to position the valve 2, and it can only move up and down but will not rotate, and the engaging hook disc 251 will not eccentrically rotate. The sealing ring 9 is mounted at the recess 17 of the valve seat 1, and the engaging seat 3 uses the hooking hole 31 at the tube body in association with the engaging hook 11 at the upper end opening of the valve seat 1, such that the engaging seat 3 is mounted onto the valve seat 1 and the two engaging hook blocks 32 at the upper end of the engaging seat 3 is in aligned with the two ends of the engaging hook disc 251 of the valve 2. When the valve 2 is pushed by the swinging rod 6 and the pushing element 5, the two ends of the engaging hook disc 251 can hook at the sloping teeth of the engaging hook block 32.

In operation, the push rod 51 of the pushing element 5 passes through the cavity chamber 24 within the tube body 22 of the valve 2. The swinging rod 6 is located at the bottom, and finally, a screw nut 7 is used to urge the pushing element 5 and the swinging rod 6 to screw onto the valve seat 1. The inner threads 71 of the screw nut 7 is associated with the external threads 18 at the bottom of the valve seat 1, and the blocking edge 72 of the screw nut 7 urges the pushing element 5 and the swinging rod 6, and mounted with the valve seat 1. The valve head 21 is mounted with a sealing ring 8 and in association with the sloping edge 12 of the valve seat 1, the elastic force of the spring 4 and the water pressure provide water leakage sealing.

The screw connection head 100 is mounted on the valve seat 1 and the hooking hole 101 of the screw connection head 100 is in alignment with the engaging hook 16 of the valve seat blocking edge 13 such that the valve seat 1 is mounted at the screw connection head 100. The upper end opening of the screw connection head 100 is provided with internal threads 102 so as to mount at the water outlet of a faucet 200 (as shown in FIG. 2).

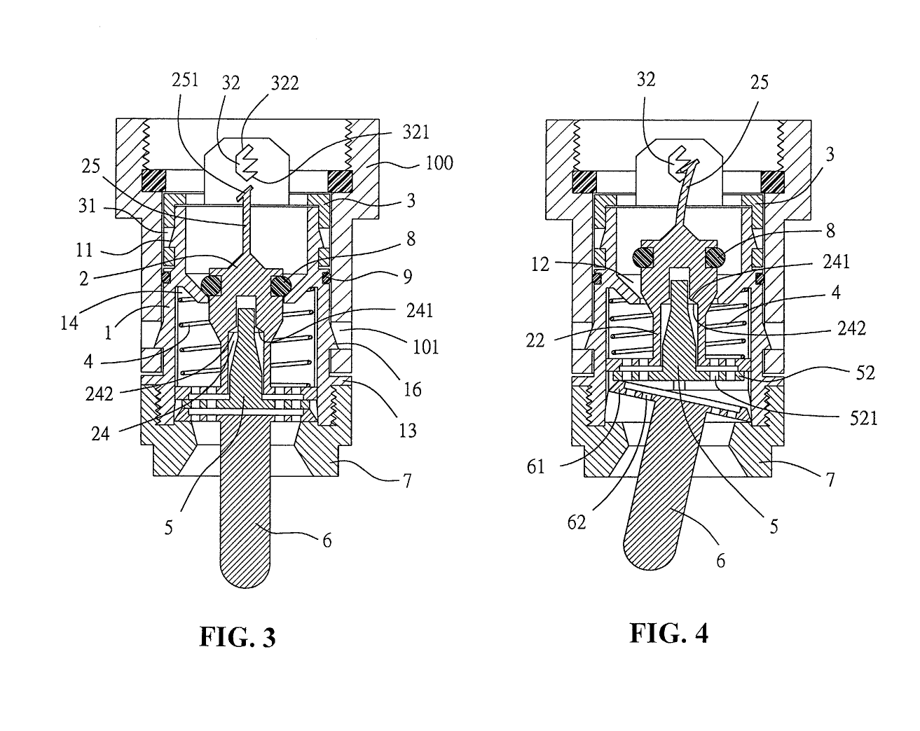

Referring to FIGS. 3 to 8 with respect to the operation procedures, when the swinging rod 6 is triggered, the support plate 61 on the swinging rod 6 will slide upward to urge the pushing plate 52 of the pushing element 5. When the pushing element 5 is urged upward, the pushing element 5 will push upward the valve 2 and the valve 2 moves upward. The sealing ring 8 moves away from the sloping edge 12, which allows water flowing via the gap formed between the tube body 22 of the valve 2 and the sloping edge 12 so as to provide low water flowrate. If the swinging rod 6 is released, the valve 2 will rapidly retract and the sealing ring 8 blocks the sloping edge 12 and water flow will stop immediately. If the swinging rod 6 continuously move due to the elasticity of the engaging hook rod 25 of the valve 2, and when the valve 2 moves upward to the engaging hook disc 251 to touch the engaging hook block 32 within the engaging seat 3, the sloping face of the engaging hook disc 251 will move along the bottom sloping face 321 of the engaging hook block 32 such that the two ends of the engaging hook disc 251 are in engagement with the sloping teeth of the engaging hook block 32, and the valve 2 is there suspended. When the sealing ring 8 of the valve head 21 and the sloping edge 12 of the valve seat 1 are dislocated, a gap is formed between the sloping conic section 221 at the outer edge of the tube body 22 and the sloping edge 12 of the valve seat 1 (as shown in FIG. 4). At this instance, the gap is comparatively small, and the water flow rate is low and it is suitable for low volume water usage.

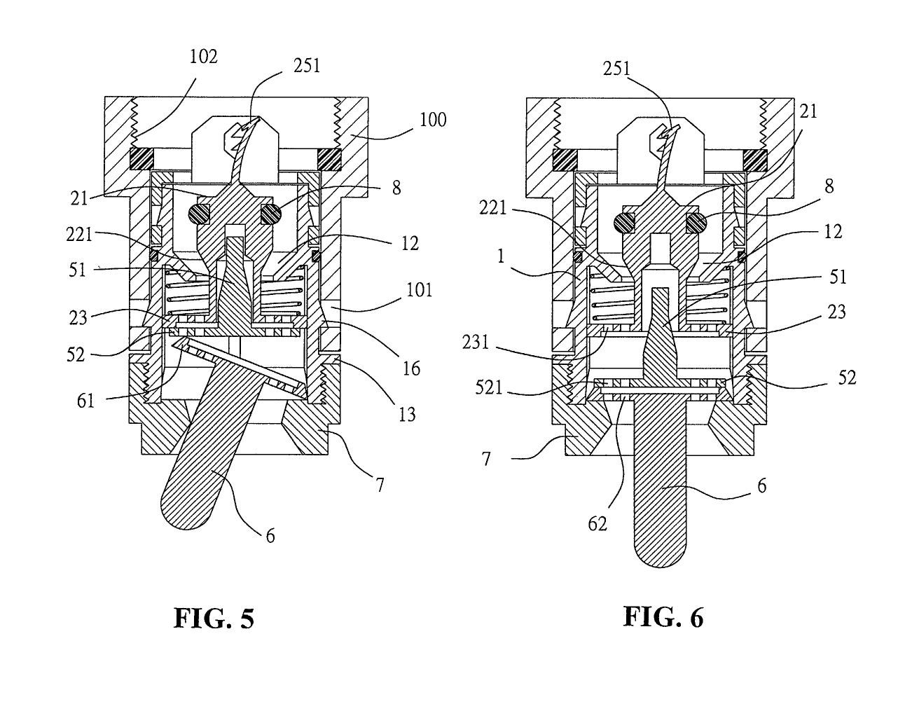

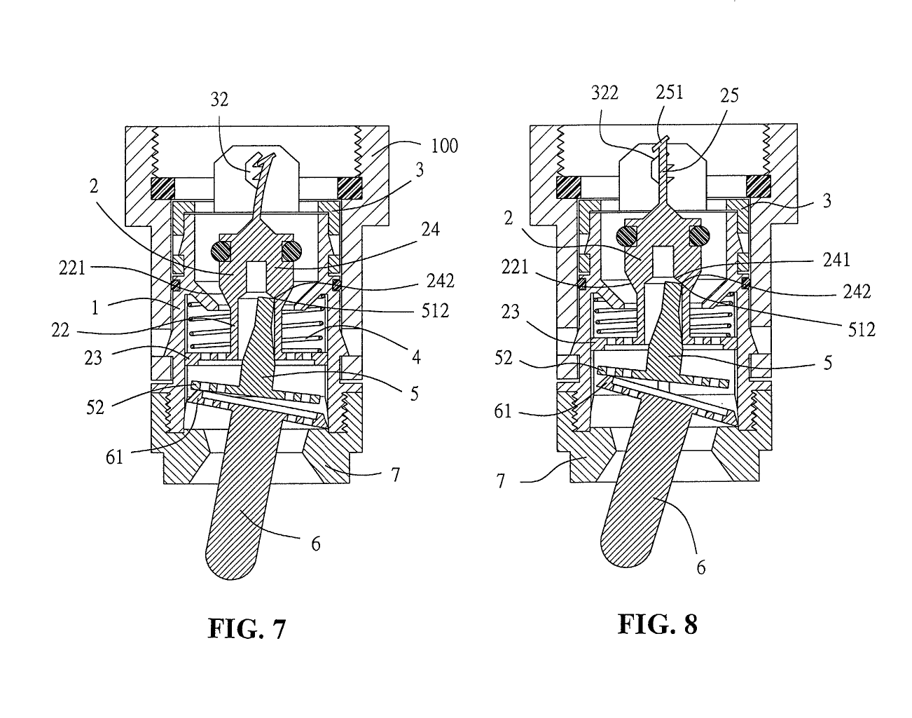

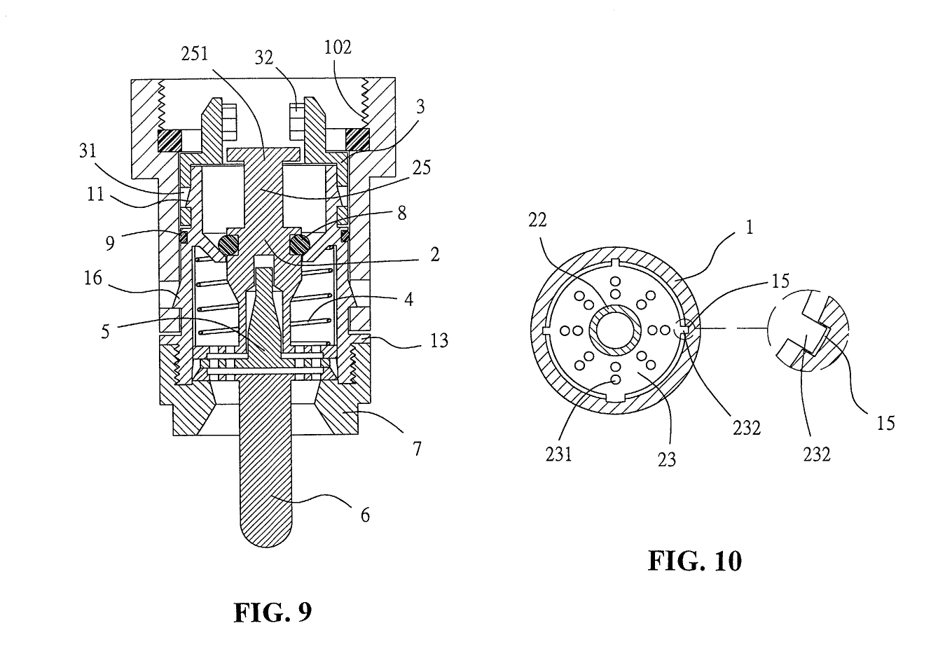

If the swinging rod 6 is triggered to a maximum, the sloping swinging angle is larger, and the sloping angle of the support plate 61 is larger, and the pushing element 5 and the valve 2 are pushed higher, such that the engaging hook disc 251 is hook on one sloping tooth of the engaging hook block 32 (as shown in FIG. 5). This is the largest swing of the swinging rod 6, and the engaging hook disc 251 of the valve 2 can only hook at the uppermost sloping tooth of the engaging hook block 32 and cannot go beyond the engaging hook block 32. At this instance, the gap between the sloping conic section 221 at the external edge of the tube body 22 and the sloping edge 12 of the valve seat 1 will become larger and the water flowrate will become larger. Based on the volume of the water flowrate, if the swinging rod 6 is released, the pushing element 5 will be lowered, and the engaging hook disc 251 hooks onto the sloping teeth of the engaging hook block 32 and is suspended (as shown in FIG. 6). If the faucet is to be turned off, the swinging rod 6 is triggered and the support plate 61 moves upward to urge the pushing plate 52. At this instance, the cavity chamber 24 has a sloping conic face 241 and is step-like with a bending region 242, and the middle section of the pushing rod 51 is provided with a conic section 511 such that the upper half of the push rod 51 has a cylindrical body with smaller diameter, and the sloping of the support plate 61 will support one side of the pushing plate 52 and the pushing element 5 is biased. The end terminal edge 512 urges the bending region 242 (as shown in FIG. 7) and the valve moves upward, and the valve 2 is pushed to the maximum point and the engaging hook disc 251 dislocates from the sloping teeth shaped engaging hook block 32 (as shown in FIG. 8), due to the elasticity of the engaging hook rod 25 the engaging hook disc 251 will become upright. When the swinging rod 6 is released, the pushing element 5 will retract, and the valve 2 will push downward by the spring force of the spring 4, and the engaging hook disc 251 will move along the sloping face 322 of the engaging hook block 32 to the other side, in this restoration of the engaging hook disc 251, the elastic force of the spring 4 is positioned together with the water pressure, and the valve 2 will rapidly restore to the bottom, and the sealing ring 8 of the valve head 21 will return to block the sloping edge 12 within the valve seat 1 so that water flow is sealed.

In accordance with the present invention, the cavity chamber 24 and the pushing rod 51 will not allow a continuous turning on to the end. This is due to the restriction of the swinging rod 6 by the screw nut 7, and the engaging hook disc 251 of the valve 2 is pushed to a maximum at the engaging hook block 32 at the uppermost sloping teeth, such that the switching off action has to be done by multi-operations. The end terminal edge 512 can only be pushed to the sloping conic face 241 of the cavity chamber by multiple operation, the upper push of the valve 2 will cause the engaging hook disc 251 to go beyond the engaging hook block 32 and returns to the sloping edge 12.

When triggering the swinging rod 6, the valve 2 is pushed upward, water from top section of the engaging seat 3 flows through the gap between the sloping conic section 221 and the sloping edge 12, and via the holes 231 and the holes 521 of the pushing plate 52, and flows out via the holes 62 at the support plate 61 of the swinging rod 6.

The volume of water from the faucet 200 is controlled by the size of the gap between the edge of the valve 1 and the sealing ring 8 of the valve head 21. The number of sloping teeth on the engaging hook block 32 can be increased so as to allow more multiple stages of water flowrate operation to comply with the need at various requirements.

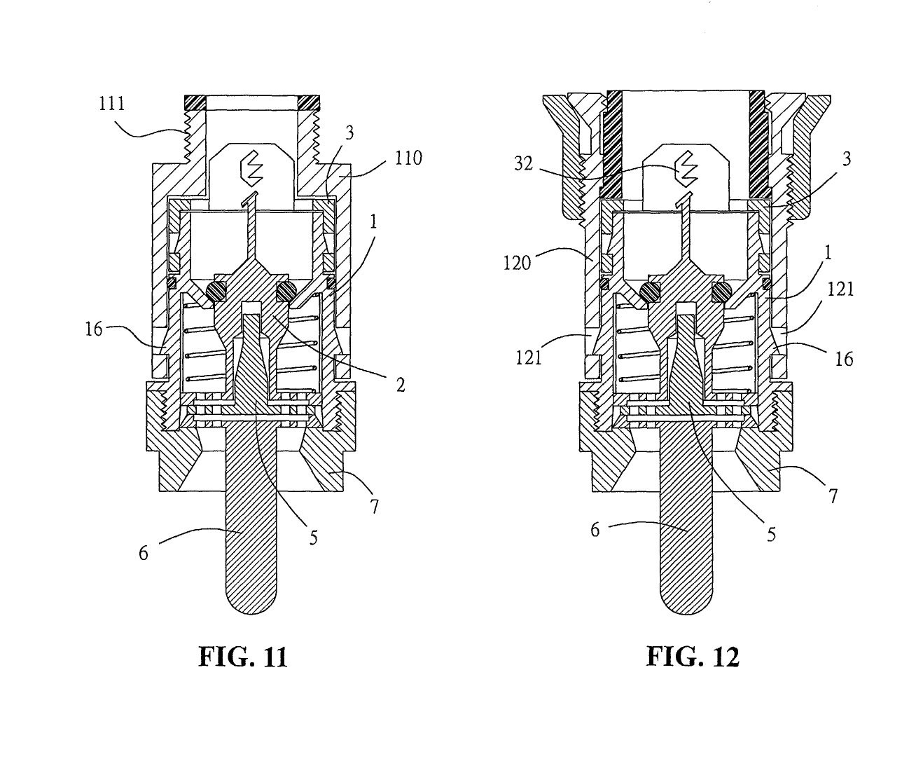

Referring to FIG. 11, there is shown another preferred embodiment of the present invention. The top end external edge of the screw connection head 110 is provided with external threads 111 to allow the mounting with the inner thread of the faucet.

Referring to FIG. 12, there is shown another preferred embodiment of the present invention. The valve seat can be mounted to a rapid connector 120 by means of the engaging hook 16, and the lower section of the rapid connector 120 is provided with hooking holes 121 corresponding to the engaging hook 16 at the top section of the block edge 13 of the valve 1 so that it can be mounted at the water outlet of other faucet or other end terminal outlet of the water pipe.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An instantaneous, multistage water-saving valve comprising
(a) a valve seat having an external edge at the upper end opening mounted with a plurality of engaging hooks, the lower ring of the engaging hook being a recess and the upper end opening provided with inner threads and sloping edge, the lower end opening being externally protruded with blocking edge, and the top of the blocking edge being a plurality of engaging hooks and the lower section being mounted with external threads, the interior of the valve seat is provided with circular slot and the inner wall of the valve seat being provided with positioning sliding slot;
(b) a valve having one end being a valve head, and the top ring of the valve head being a recess for the mounting with a sealing ring, the external edge of the tube body being a sloping conic section and the lower end thereof being a support plate, the support plate and the center of the tube body being a cavity chamber having a sloping conic face, the lower section of the sloping conic face being a bending region, and the support plate being a plurality of holes, the side edge of the support plate being a plurality of positioning blocks, and the valve head being an engaging rod with elasticity, the top end of the engaging rod connected to a engaging hook disc;
(c) an engaging seat having a hollow tubular body with the top ring of the tube body being provided with a plurality of hooking holes, and the interior of the upper end being a pair of sloping shaped engaging block
(d) a pushing element having a conic section at the middle section of the push rod of the upper section thereof such that the upper half of the push rod being a smaller cylindrical body;
the engaging hook disc of the valve head in association with the engaging block within the engaging seat and by means of the swinging of the swinging rod, the pushing plate being supported and the upper movement of the push element and the valve, the engaging hook disc being engaged with the sloping teeth structure of the engaging block, thereby water flows from the lower section of the sealing ring to the valve seat, and via the gap between the sloping conic section of the valve tube body and the sloping blocking edge of the valve seat, the engaging position of the engaging hook disc with the sloping teeth structure, the flow rate of water flow is regulated.

2. An instantaneous, multistage water-saving valve as set forth in claim 1, wherein the sloping teeth shaped engaging hook block of the engaging seat is provided with more sloping teeth so as to provide more stages of water flow rate.
